(19) United States
(12) Patent Application Publication
(10) Pub. No.: US 2009/0046885 A1
(43) Pub. Date: Feb. 19, 2009

(54) Speaker damper mounting structure

(75) Inventor: Steff Lin, Taipei Hsien (TW)

Correspondence Address: BACON & THOMAS, PLLC, 625 SLATERS LANE, FOURTH FLOOR, ALEXANDRIA, VA, 22314-1176, US

(73) Assignee: HI-TECH SOUND SYSTEM CO., LTD., TAIPEI (TW)

(21) Appl. No.: 11/889,789

(22) Filed: Aug. 16, 2007

(51) Int. Cl. H04R 1/02

(52) U.S. Cl. 381/392

(57) ABSTRACT

A speaker damper mounting structure used in a speaker to hold a damper firmly to a voice coil is disclosed to include an upper bearing cup, which is fastened to the paper cone of the speaker to hold the damper around the voice coil and having an inner horizontal segment, an annular flange perpendicularly downwardly extending from the inner horizontal segment and inserted through the center through hole of the damper, and a plurality of locating holes cut through the inner horizontal segment corresponding to respective mounting holes of the damper, and a bottom bearing cup, which has an inner step stopped at the bottom side of the damper against the upper bearing cup and a plurality of top hooks respectively inserted through the mounting holes of the damper and fastened to the locating holes of the upper bearing cup.

### BACKGROUND OF THE INVENTION

1. Field of the Invention

The present invention relates to speakers and more particularly, to a speaker damper mounting structure, which prohibits disconnection of the damper from the voice coil during vibration of the voice coil, thereby improving the service life of the speaker.

2. Description of the Related Art

FIGS. 1 and 2 show a conventional speaker 1, which comprises a bracket 14, a T-iron 11, an annular magnet 12 supported on the T-iron 11, a washer 13 covered on the magnet 12 opposite to the T-iron 11 and fastened with the magnet 12 and the T-iron 11 to the bottom side of the bracket 14, a voice coil 16 wound round the axle bush at the center of the T-iron 11 and suspending in the magnet 12, a damper 15 inside the bracket 14 around the voice coil 16, a paper cone 17 mounted on the top side of the bracket 14 and fastened to the top end of the axle bush, a dust cap 18, and a rubber packing 19 fastened to the periphery of the bracket 14. The voice coil 16 is inserted through the paper cone 17, and then bonded to the damper 15 and the paper cone 17 with a glue. Because the bonding area between the voice 16 and the damper 15 is limited, the glue may be melted by heat that is produced during vibration of the voice coil 16, thereby causing disconnection of the voice coil 16 from the damper 15.

Therefore, it is desirable to provide a speaker damper mounting structure that eliminates the aforesaid problem.

### SUMMARY OF THE INVENTION

The present invention has been accomplished under the circumstances in view. It is therefore the main object of the present invention to provide a speaker damper mounting structure, which prohibits disconnection of the damper from the voice coil during vibration of the voice coil, thereby improving the service life of the speaker.

To achieve this and other objects of the present invention, an upper bearing cup and a bottom bearing cup are used and installed in the speaker at the top and bottom sides of the damper to secure the damper firmly to the voice coil.

The upper bearing cup is fastened to the paper cone of the speaker to hold the damper around the voice coil, having an inner horizontal segment, an annular flange perpendicularly downwardly extending from the inner horizontal segment and inserted through the center through hole of the damper, and a plurality of locating holes cut through the inner horizontal segment corresponding to respective mounting holes of the damper. The bottom bearing cup is fastened to the upper bearing cup to hold down the damper, having an inner step stopped at the bottom side of the damper against the upper bearing cup, and a plurality of top hooks respectively inserted through the mounting holes of the damper and fastened to the locating holes of the upper bearing cup.

In another embodiment of the present invention, the upper bearing cup and the bottom bearing cup and fastened to the voice coil to hold down the damper, and a holding down ring is fastened to the upper bearing cup, the damper, and the bottom bearing cup to secure the damper and the bearing cups together.

### BRIEF DESCRIPTION OF THE DRAWINGS

FIG. 1 is an exploded view of a speaker according to the prior art.

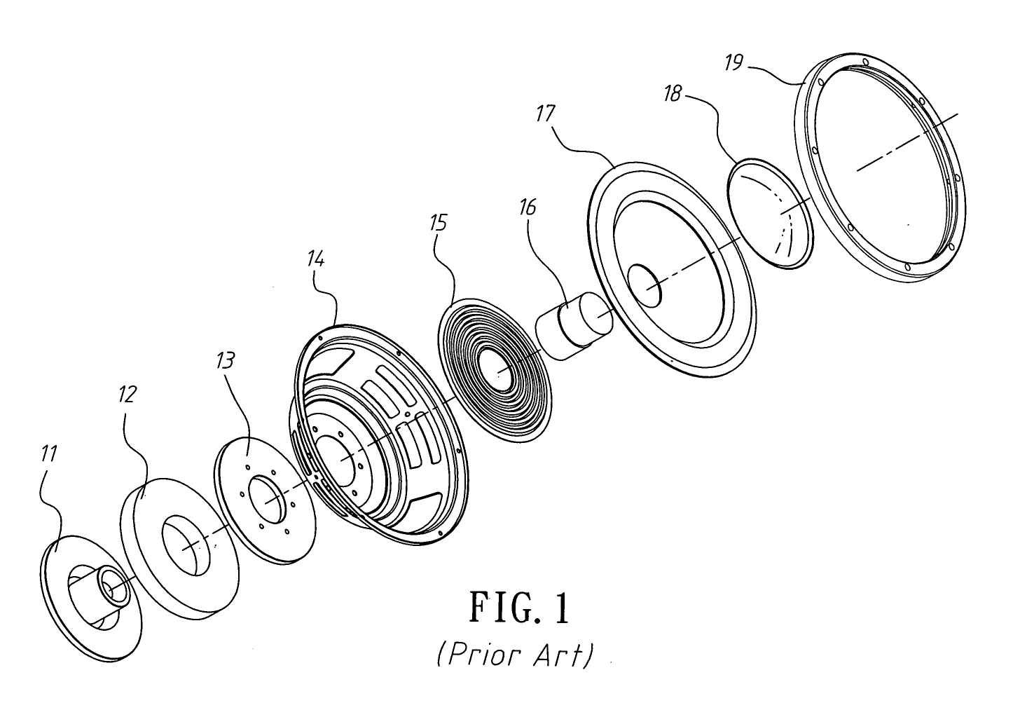

FIG. 2 is a sectional assembly view in an enlarged scale of the speaker shown in FIG. 1.

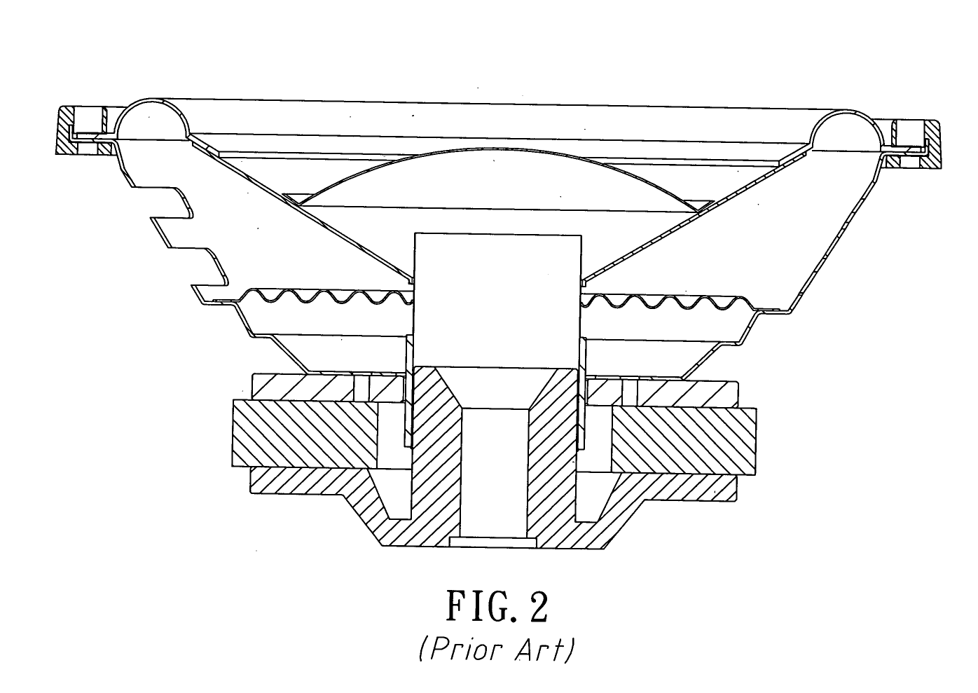

FIG. 3 is an exploded view of a speaker in accordance with a first embodiment of the present invention.

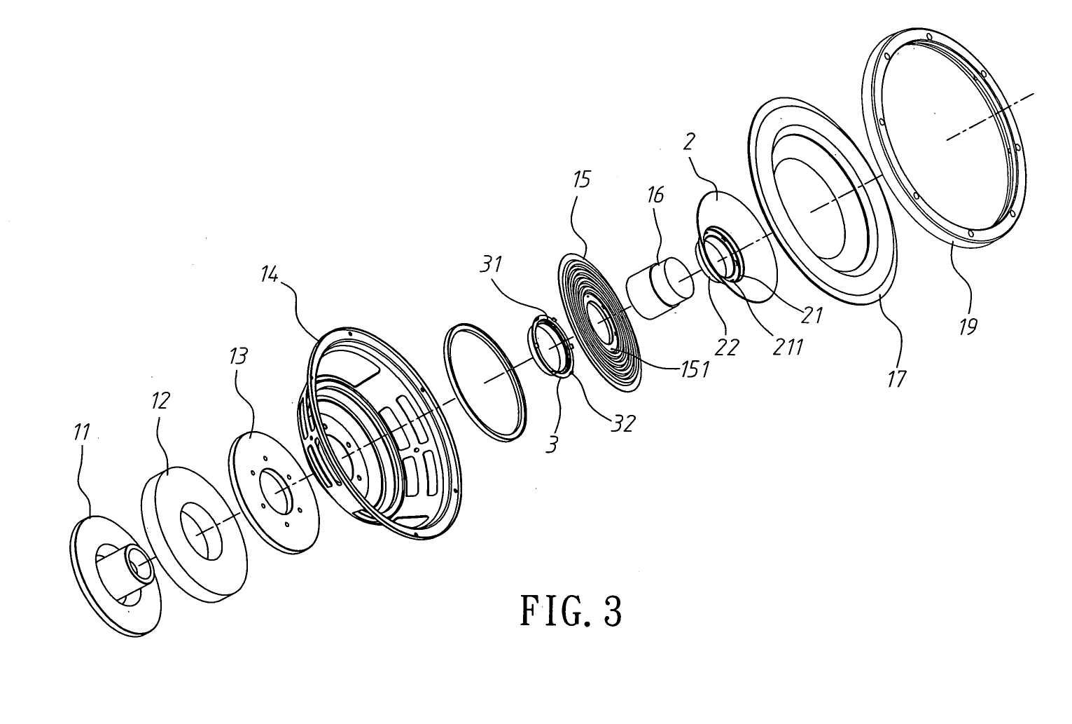

FIG. 4 is an enlarged view of a part of FIG. 3 showing the detail of the speaker damper mounting structure.

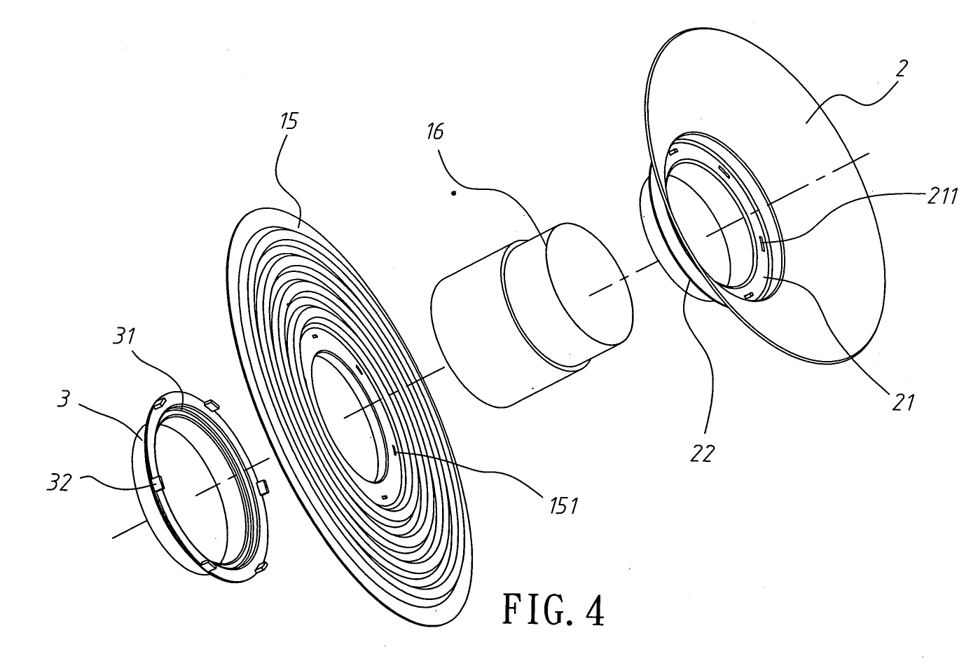

FIG. 5 is a sectional assembly view in an enlarged scale of the speaker shown in FIG. 3.

FIG. 6 is an exploded view of a speaker in accordance with a second embodiment of the present invention.

FIG. 7 is an enlarged view of a part of FIG. 6 showing the detail of the speaker damper mounting structure.

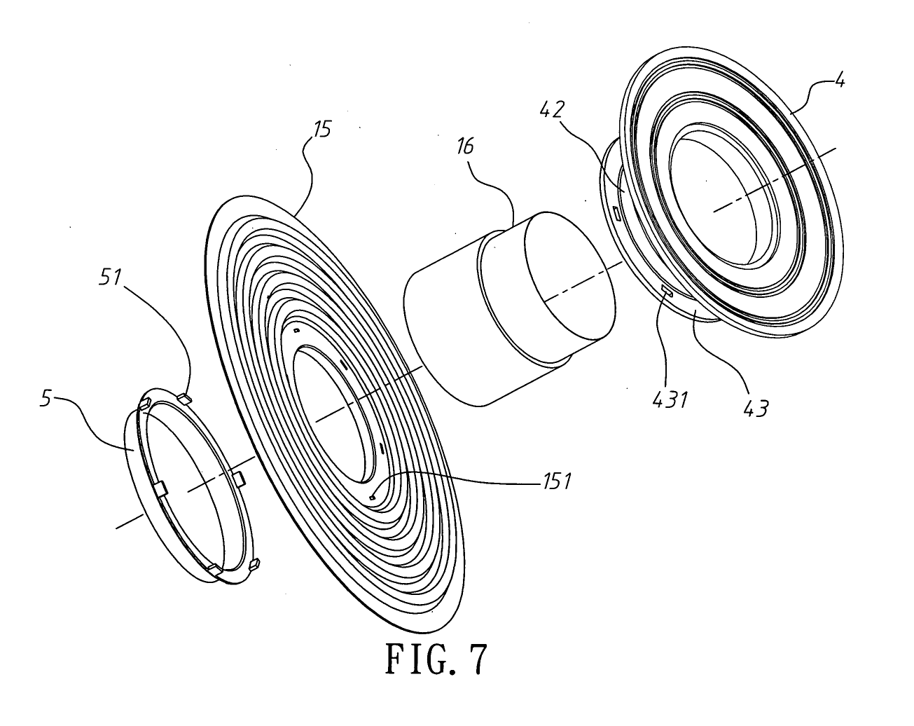

FIG. 8 is a sectional assembly view in an enlarged scale of the speaker shown in FIG. 6.

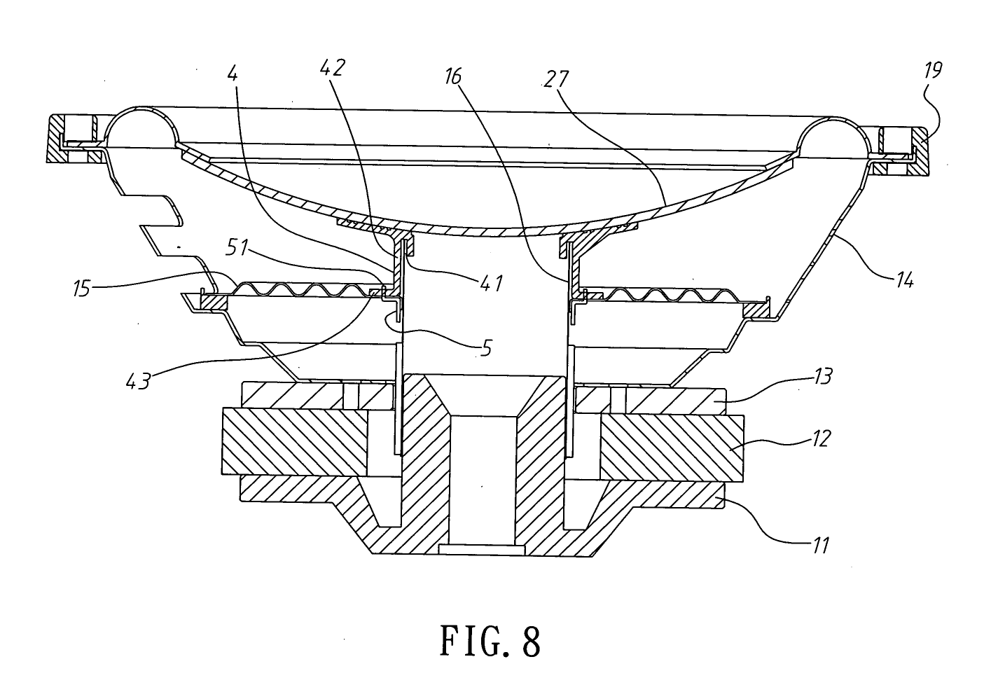

FIG. 9 is an exploded view of a speaker in accordance with a third embodiment of the present invention.

FIG. 10 is an enlarged view of a part of FIG. 9 showing the detail of the speaker damper mounting structure.

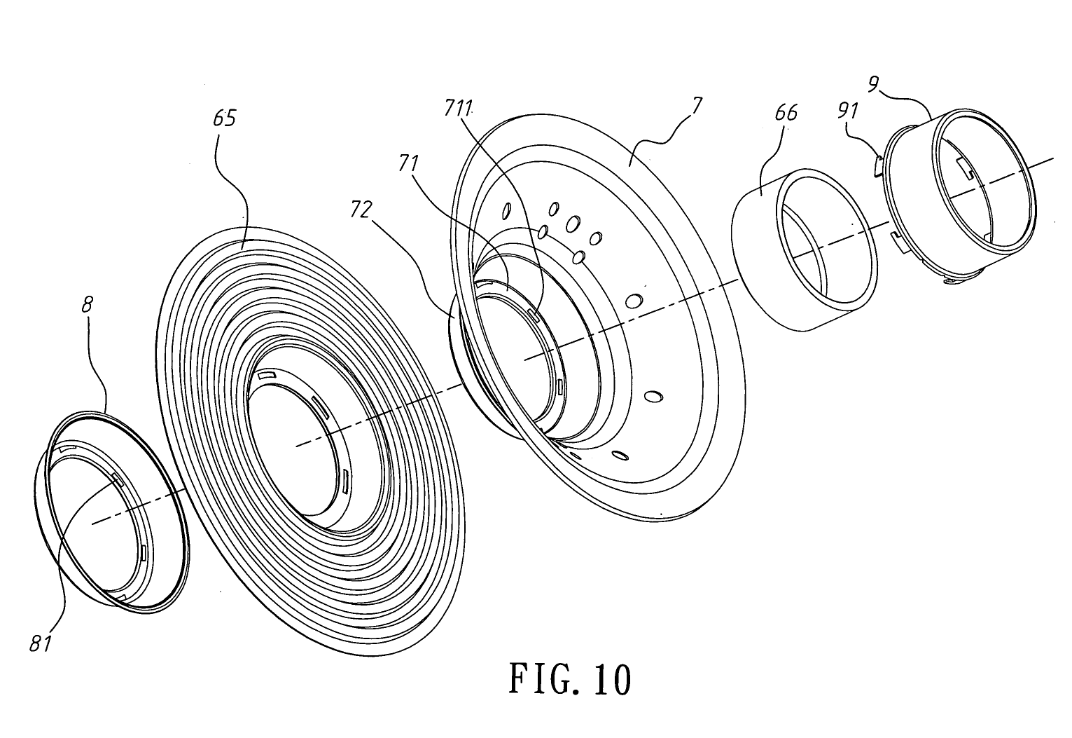

FIG. 11 is a sectional assembly view in an enlarged scale of the speaker shown in FIG. 9.

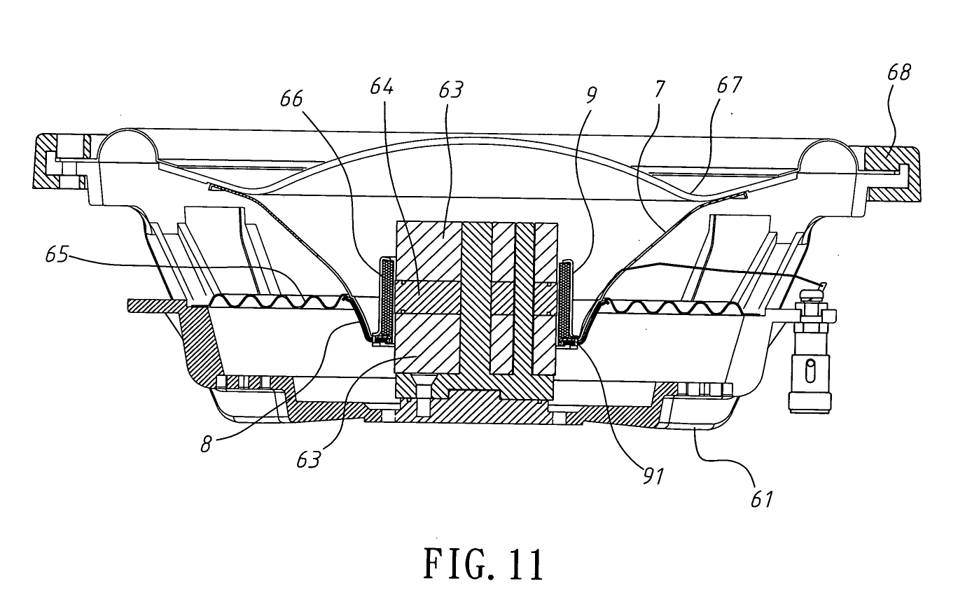

### DETAILED DESCRIPTION OF THE PREFERRED EMBODIMENT

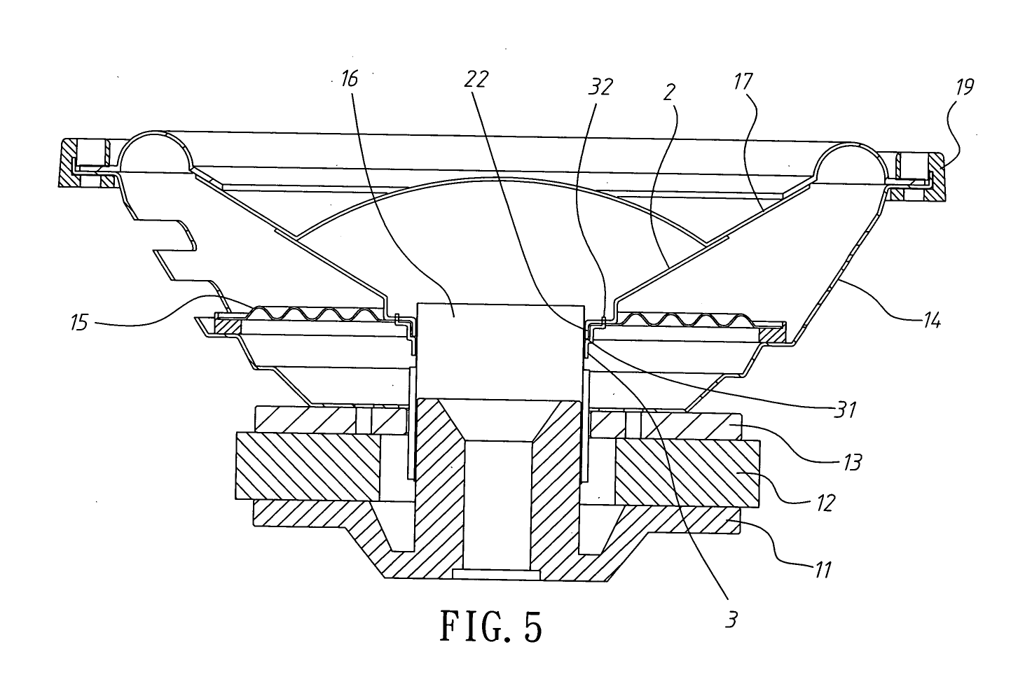

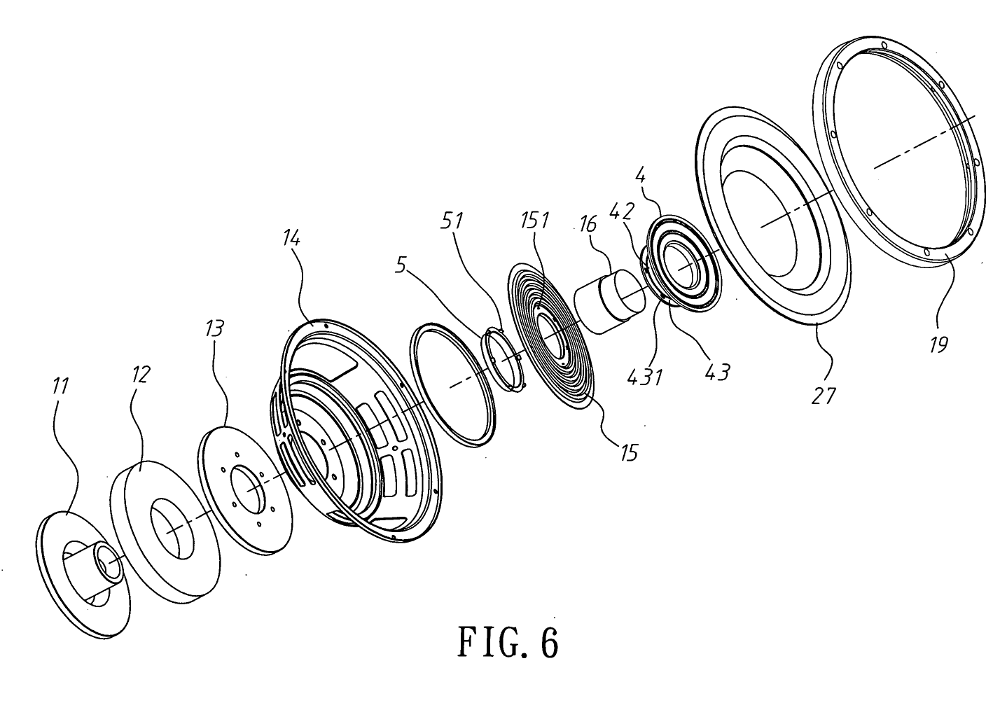

Referring to FIGS. 5 and 6, a speaker damper mounting structure in accordance with a first embodiment of the present invention is shown used in a speaker, which comprises a bracket 14, a T-iron 11, an annular magnet 12 supported on the T-iron 11, a washer 13 covered on the top side of the magnet 12 opposite to the T-iron 11 and fastened with the magnet 12 and the T-iron 11 to the bottom side of the bracket 14, a voice coil 16 suspending in the magnet 12, a damper 15 mounted within the bracket 14 around the voice coil 16, a paper cone 17 mounted on the top side of the bracket 14, a packing rubber 19 fastened to the periphery of the bracket 14. The damper 15 is an annular member having a plurality of mounting holes 151 equiangularly spaced around its center through hole.

The speaker damper mounting structure comprises an upper bearing cup 2 and a bottom bearing cup 3. The upper bearing cup 2 is connected to the paper cone 17, having an inner horizontal segment 21, an annular flange 22 perpendicularly downwardly extending from the inner horizontal segment 21, and a plurality of locating holes 211 cut through the inner horizontal segment 21 corresponding to the mounting holes 151 of the damper 15.

The bottom bearing cup 3 is an annular member having an inner step 31, and a plurality of top hooks 32 corresponding to the mounting holes 151 of the damper 15 and the locating holes 211-of the upper bearing cup 2.

During installation, the hooks 32 of the bottom bearing cup 3 are respectively hooked in the mounting holes 151 of the damper 15 and the locating holes 211 of the upper bearing cup 2 and then the assembly of the damper 15 and bearing cups 2 and 3 is capped on the voice coil 16 to have one end of the damper 15 be sandwiched in between the annular flange 22 of the upper bearing cup 2 and the step 31 of the bottom bearing cup 3, and therefore the damper 15 is firmly secured in place between the upper bearing cup 2 and the bottom bearing cut 3, prohibiting disconnection of the damper 15 from the speaker during oscillation of the voice coil 16.

FIGS. 6˜8 a speaker damper mounting structure in accordance with a second embodiment of the present invention is shown used in a speaker, which comprises a bracket 14, a T-iron 11, an annular magnet 12 supported on the T-iron 11, a washer 13 covered on the top side of the magnet 12 opposite to the T-iron 11 and fastened with the magnet 12 and the T-iron 11 to the bottom side of the bracket 14, a voice coil 16 suspending in the magnet 12, a damper 15 mounted within the bracket 14 around the voice coil 16, a different design of paper cone 27 mounted on the top side of the bracket 14, a packing rubber 19 fastened to the periphery of the bracket 14. The damper 15 is an annular member having a plurality of mounting holes 151 equiangularly spaced around its center through hole.

The speaker damper mounting structure comprises an upper bearing cup 4 and a bottom bearing cup 5. The upper bearing cup 4 is connected to the paper cone 27, having a tubular shaft 42, a downwardly extending annular center plughole 41 defined within the tubular shaft 42, a horizontal flange 43 perpendicularly extending around the bottom side of the periphery of the tubular shaft 42, and a plurality of locating holes 431 cut through the top and bottom sides of the horizontal flange 43 corresponding to the mounting holes 151 of the damper 15.

The bottom bearing cup 5 is an annular member having a plurality of top hooks 51 corresponding to the mounting holes 151 of the damper 15 and the locating holes 431 of the upper bearing cup 4.

During installation, the hooks 51 of the bottom bearing cup 5 are respectively hooked in the mounting holes 151 of the damper 15 and the locating holes 4311 of the upper bearing cup 4 and then the assembly of the damper 15 and bearing cups 4 and 5 is capped on the voice coil 16 to have the top end of the voice coil 16 be secured to the annular plughole 41 of the upper bearing cup 4 and the damper 15 be sandwiched in between the horizontal flange 43 of the upper bearing cup 4 and the bottom bearing cup 5, and therefore the damper 15 is firmly secured in place between the upper bearing cup 4 and the bottom bearing cut 5, prohibiting disconnection of the damper 15 from the speaker during oscillation of the voice coil 16.

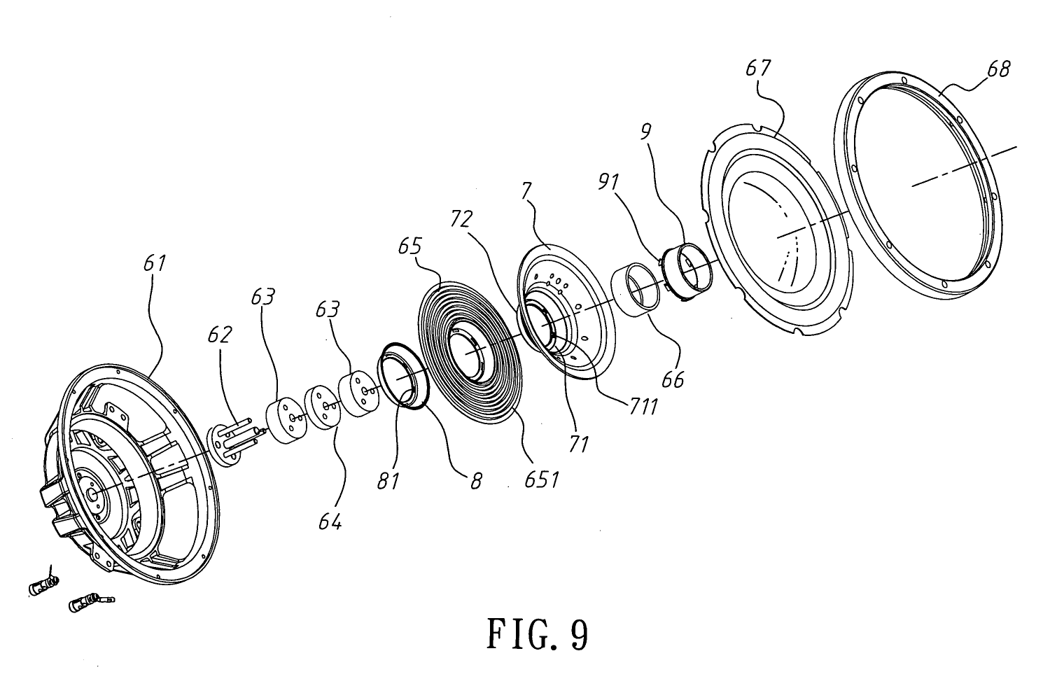

Referring to FIGS. 9˜11, a speaker damper mounting structure in accordance with a third embodiment of the present invention is shown used in an internal magnet type speaker, which is comprised of an aluminum bracket 61, an aluminum post 62 mounted in the aluminum bracket 61 at the center, two magnets 63 mounted on the aluminum post 62, a washer 64 set between the magnets 63 on the aluminum post 62, a damper 65 mounted in the aluminum bracket 61 around the aluminum post 62, a voice coil 66 mounted in the aluminum bracket 61 around the magnets 63 within the damper 65, a paper cone 67 suspending in the aluminum bracket 61 at the top above the damper 65 and the voice coil 66, and a packing rubber 68 fastened to the periphery of the aluminum bracket 61. The damper 65 is an annular member having a plurality of mounting holes 651 equiangularly spaced around its center through hole.

The speaker damper mounting structure comprises an upper bearing cup 7, a bottom bearing cup 8, and a holding down ring 9. The upper bearing cup 7 is connected to the paper cone 67, having an inner horizontal segment. 71, an annular flange 72 perpendicularly downwardly extending from the inner horizontal segment 71, and a plurality of locating holes 711 cut through the inner horizontal segment 71 corresponding to the mounting holes 651 of the damper 65.

The bottom bearing cup 8 is an annular member having a plurality of mounting holes 81 corresponding to the mounting holes 651 of the damper 65 and the locating holes 711 of the upper bearing cup 7.

The holding down ring 9 has a plurality of bottom hooks 91 corresponding to the mounting holes 651 of the damper 65 and the locating holes 711 of the upper bearing cup 7 and the mounting holes 81 of the bottom bearing cup 8.

During installation, the bottom hooks 91 of the holding down ring 9 are respectively hooked in the locating holes 711 of the upper bearing cup 7 and the mounting holes 651 of the damper 65 and the mounting holes 81 of the bottom bearing cup 8, and then the assembly of the damper 65 and bearing cups 7 and 8 and holding down ring 9 is capped on the voice coil 66 to have one end of the damper 65 be sandwiched in between the annular flange 72 of the upper bearing cup 7 and the bottom bearing cup 8, and therefore the damper 615 is firmly secured in place between the upper bearing cup 7 and the bottom bearing cut 8, prohibiting disconnection of the damper 65 from the speaker during oscillation of the voice coil 66.

As indicated above, the invention a speaker damper mounting structure, which uses an upper bearing cup and a bottom bearing cup to secure the damper firmly to the voice coil, preventing falling of the damper from the speaker.

Although particular embodiments of the invention have been described in detail for purposes of illustration, various modifications and enhancements may be made without departing from the spirit and scope of the invention. Accordingly, the invention is not to be limited except as by the appended claims.

What the invention claimed is:

1. A speaker damper mounting structure comprising:
a damper, said damper having a plurality of mounting holes equiangularly spaced around a center through hole thereof;
an upper bearing cup fastened to a paper cone in a speaker for holding said damper around a voice coil, said upper bearing cup, having an inner horizontal segment, an annular flange perpendicularly downwardly extending from said inner horizontal segment and inserted through the center through hole of said damper, and a plurality of locating holes cut through said inner horizontal segment corresponding to the mounting holes of said damper and
a bottom bearing cup fastened to said upper bearing cup to hold down said damper, said bottom bearing cup having an inner step stopped at a bottom side of said damper against said upper bearing cup, and a plurality of top hooks respectively inserted through the mounting holes of said damper and fastened to the locating holes of said upper bearing cup.

2. A speaker damper mounting structure comprising:
a damper, said damper having a plurality of mounting holes equiangularly spaced around a center through hole thereof;
an upper bearing cup fastened to a paper cone in a speaker for holding said damper, said upper bearing cup having a tubular shaft inserted through the center through hole of said damper, a downwardly extending annular center plughole defined within said tubular shaft and coupled to a voice coil in said speaker, horizontal flange perpendicularly extending around the periphery of said tubular shaft, and a plurality of locating holes cut through top and bottom sides of said horizontal flange corresponding to the mounting holes of said damper and
a bottom bearing cup fastened to said upper bearing cup and stopped at a bottom side of said damper against the horizontal flange of said upper bearing cup to hold down said damper, said bottom bearing cup having a plurality of top hooks respectively inserted through the mounting holes of said damper and fastened to the locating holes of said upper bearing cup.

3. A speaker damper mounting structure comprising:
a damper, said damper having a plurality of mounting holes equiangularly spaced around a center through hole thereof;
an upper bearing cup connected to a paper cone in a speaker and attached to a top side of said damper, said upper bearing cup having an inner horizontal segment, an annular flange perpendicularly extending from said inner horizontal segment and inserted through the center through hole of said damper and sleeved onto a voice coil, and a plurality of locating holes cut through said inner horizontal segment corresponding to the mounting holes of said damper
a bottom bearing cup attached to a bottom side of said damper and fastened to said upper bearing cup to hold down said damper, said bottom bearing cup having a plurality of mounting holes corresponding to the mounting holes of said damper and the locating holes of said upper bearing cup; and
a holding down ring, said holding down ring having a plurality of bottom hooks respectively fastened to the mounting holes of said damper and the locating holes of said upper bearing cup and the mounting holes of said bottom bearing cup to secure said damper to said upper bearing cup and said bottom bearing cup.
